(19) United States
(12) Patent Application Publication
(10) Pub. No.: US 2007/0236667 A1
(43) Pub. Date: Oct. 11, 2007

(54) Apparatus for displaying an image employing a reflective surface

(75) Inventors: Theodore Basil Staros, Carlsbad, CA (US); Dennis Peter Kerkhof, Oceanside, CA (US); Joe John Dombrowski, San Marcos, CA (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Harris Corporation

(21) Appl. No.: 11/401,554

(22) Filed: Apr. 11, 2006

(51) Int. Cl. G03B 15/08

(52) U.S. Cl. 352/244

(57) ABSTRACT

Apparatus for displaying an image wherein the apparatus includes an image light source that transmits light along a first direction. A transparent plate having forward facing and rearward facing opposing surfaces is provided. The rearward facing surface has a reflective layer and is oriented at an oblique angle relative to the first direction so that image light is reflected therefrom along a second rearward direction toward the operator. Light control means is interposed between the light source and the transparent plate in such a manner that it restricts viewing of the image at locations forward of the plate while permitting viewing of the image at locations rearward of the plate.

### BACKGROUND OF THE INVENTION

1. Technical Field

The present invention relates to an image display apparatus and, more particularly, to an improved display apparatus employing a reflective surface.

2. Description of the Prior Art

In the broadcast industry, equipment is frequently located in a studio. The studio may contain radio or television equipment. In the past, audio metering equipment is located in the studio on a desk or console at which an operator is stationed for purposes of monitoring the metering equipment. The upper surface of the console may be flat, and in the past a solid structure has been employed to hold the meters and other display devices, such as a clock and/or an event timer. This structure is located above the horizontal level of the console. This often interrupts the sight lines between the console operator, located behind the console, and studio guests, located forward of the console.

It is desirous to provide means for displaying an image with a reflection surface so that the console operator may view a reflection from the surface while guests on the other side (forward of the console) do not view the image. This is particularly so in a broadcast studio where the operator is viewing various audio level meter readings and does not want a guest on the other side of the console to see and appreciate the readings. Additionally, it is desirable to provide such a device that eliminates having a large metering bridge physically located above the console which would disrupt the sight lines between the console operator behind the console and guests located forward of the console.

It is also desirable that the image displaying device not be bulky while enhancing the aesthetic appeal while providing improved sight lines.

Still further, it is desirable that such an image displaying device employ a reflective surface that is angled to reflect an image toward a console operator located behind the console while limiting the viewing of the image at a location forward of the console. Thus, a guest located forward of the console may be able to see the operator without being able to view the image. This permits the console operator to view the meter display reflected from the reflective surface while maintaining a clear visual contact with the guests.

### SUMMARY OF THE INVENTION

In accordance with one aspect of the present invention, the image display apparatus includes an image light source that transmits light along a first direction. A transparent plate having forward facing and rearward facing opposing surfaces is provided. The rearward facing surface has a reflective layer and is oriented at an oblique angle relative to the first direction so that image light is reflected therefrom along a second rearward direction toward the operator. Light control means is interposed between the light source and the transparent plate in such a manner that it restricts viewing of the image at locations forward of the plate while permitting viewing of the image at locations rearward of the plate.

In accordance with another aspect of the present invention, the light control means takes the form of a light control film;

in accordance with a still further aspect of the present invention, the light control film takes the form of polarizing film.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is an elevational view, in section, of one embodiment of the invention;

FIG. 2 is a perspective view illustrating one embodiment of the invention as viewed from a location forward of the operator's console;

FIG. 3 is a perspective view taken from a position located rearward of the operator's console; and

FIG. 4 is a view similar to that of FIG. 1 but illustrating a second embodiment of the invention.

### DETAILED DESCRIPTION

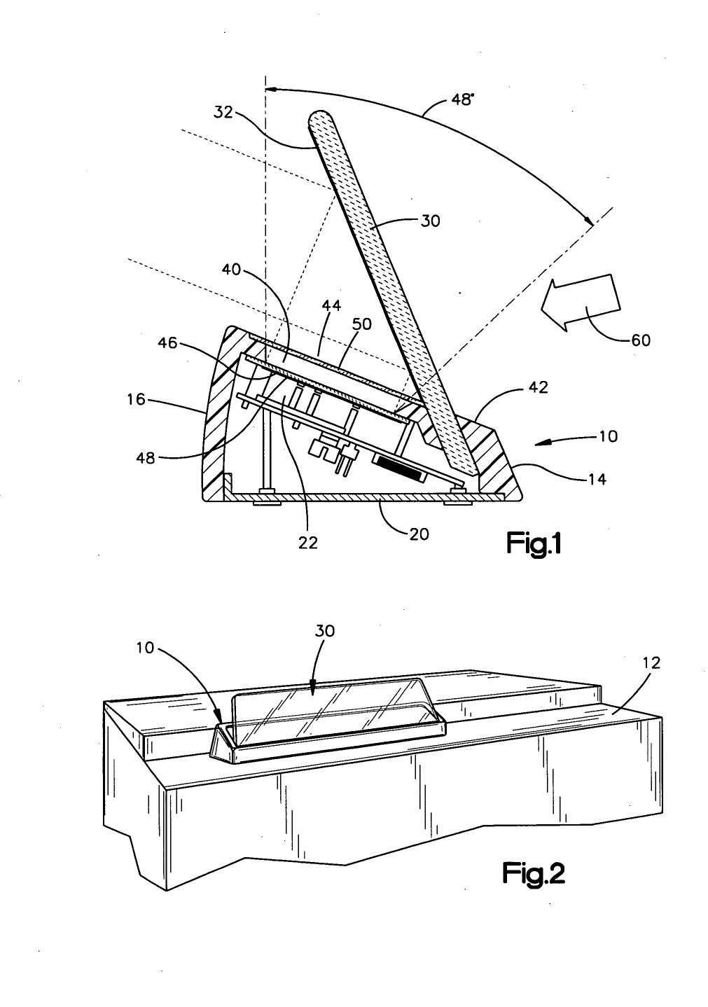

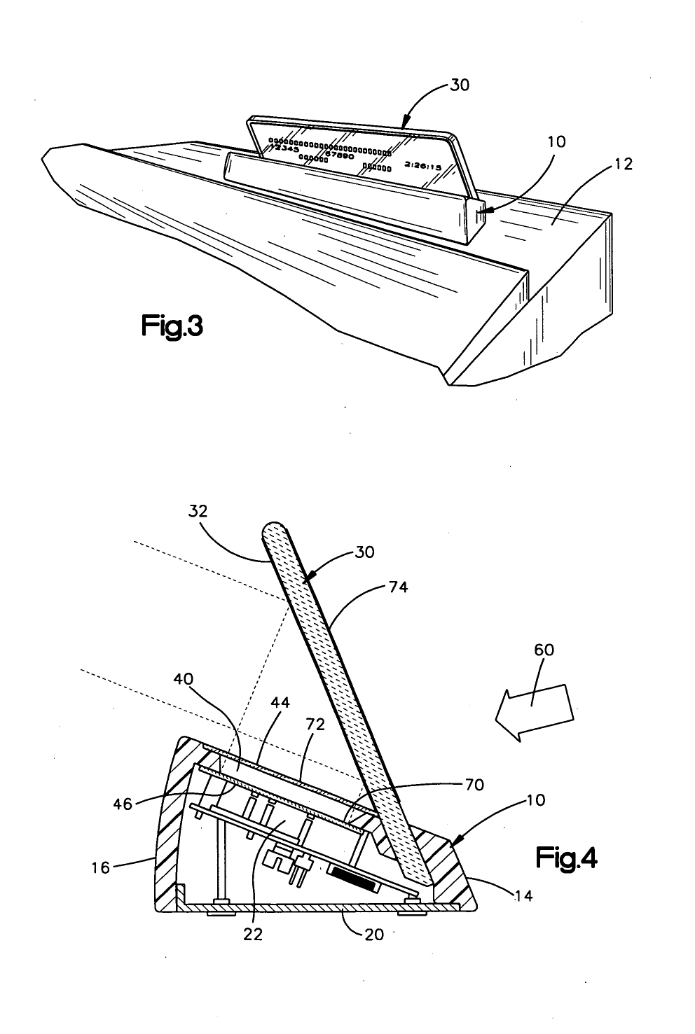

The display apparatus in accordance with the present invention, and as illustrated in the drawings herein, includes a housing 10. The housing may be of any suitable material (such as plastic) and may rest on or be secured to the upper surface of an operator's desk or console 12. The housing may also be integrated into the construction of an audio console. The housing illustrated in FIG. 1, has a forward facing surface 14 and a rearward facing surface 16. The operator would normally be located behind or rearward of surface 16 of the housing for viewing instrumentation located on the console, as well as the display apparatus associated with the housing 10. A visitor would normally be located forward of surface 14 of the housing. The housing includes a floor 20 that supports a printed circuit board assembly, along with display components that make up an image light source 22. This image light source may include several different meters, such as audio meters and other display devices such as clock and event timers. Taken together, this metering structure forms an image light source that provides metering information and the like to an operator. The operator may be located at a broadcast studio or the like and wherein the operator interacts with guests or performers. It should be noted that the image light source may also include display screens of raster or vector, display methodology, such as might be embodied by LED, LCD, or OLED technology. It is desirable to maintain clear sight lines between the operator and the guests while also permitting the operator to view performance data such as signal levels, event timing, clock timing or other indications of performance.

As shown in the drawings, the housing suitably supports a plate 30 constructed of transparent plastic material and wherein the plate extends upwardly from the housing at an oblique angle about 30°, relative to vertical, toward the operator located rearward of the housing. This plate extends from a location forward of an opening 40 in the upper surface of the housing so that image light from the image light source 22 may extend toward the plate 30. The rearward facing surface of plate 30 has a mirror or reflective layer 32 thereon. The image is reflected by layer 32. This permits the operator to see the image presented by the image light source so that the operator may be able to view the presented information, such as signal levels, event timing, clock time or other indications of performance. The opening 40 in the upper surface 42 of the housing 10 provides an upper window area 44 and a lower window area 46. The upper surface 42 is angled by about 30° from horizontal.

In the embodiment illustrated in FIG. 1, the lower window area 46 is covered with light control film 48 and the upper window area 44 is covered with a transparent polycarbonate layer 50. The control film 48 restricts the field of view to approximately 48° as viewed in FIG. 1. This is because the control film 48 is a micro-louvered film such as “VIKUITI” film provided by 3M Corporation. This limits the vertical off axis viewing of the display elements, i.e., the metering, clock and timer devices that constitute the image light source.

The visitor may see through the plate 30 at locations beyond the 48° field of view as is indicated by the arrow 60 to see the operator located on the rearward side of the housing 10. This permits interaction of the operator and the visitor while also permitting the operator to view the performance data which is not visible to the guest located forward of the console.

Reference is now made to FIG. 4, which illustrates an embodiment similar to that shown in FIG. 1, and accordingly, like components are identified in both figures with like character references.

In the embodiment illustrated in FIG. 4, the lower window opening 46 is covered with a transparent layer 70 so that light may pass therethrough from the image light source 22. However, the upper opening 44 is covered with a polycarbonate layer together with a polarizing film 72. Also, the forward facing surface of plate 30 is covered with a polarizing film 74. The film 74 is an opposing film (rotated) relative to that film 72. The films 72 and 74 serve to obscure the display visibility to the guests in a manner similar to that in the embodiment of FIG. 1. These are circular or linear polarizers with one being located on top of the window area 44 and the other film 74 being located on plate 30 as is indicated in FIG. 4. These are constructed in a position so as to limit the view by the operator to about 48° in the manner as shown in FIG. 1.

Although the foregoing has been described in conjunction with a preferred embodiment, it is to be appreciated that various modifications may be made without departing from the spirit and scope of the invention as defined by the appended claims.

1. Apparatus for displaying an image comprising:
an image light source that transmits non-polarized image light along a first direction;
a transparent plate having forward facing and rearward facing opposing surfaces with said rearward facing surface having a non-polarizing reflective layer thereon and oriented at an oblique angle relative to said first direction to thereby reflect said image non-polarized light along a second rearward direction toward an operator located rearward of said plate for display thereto; and
light control means interposed between said light source and said plate that restricts viewing of said image at locations forward of said forward surface of said plate.

2. Apparatus as set forth in claim 1 wherein said light control means includes a control film.

3. Apparatus as set forth in claim 2 wherein said light control film includes a polarizing film.
